(19) United States
(12) Patent Application Publication
(10) Pub. No.: US 2004/0232717 A1
(43) Pub. Date: Nov. 25, 2004

(54) Automobile exterior component made from resin

(76) Inventor: Hideyuki Ariyasu, Fujisawa (JP)

Correspondence Address: BIRCH STEWART KOLASCH & BIRCH, PO BOX 747, FALLS CHURCH, VA, 22040-0747, US

(21) Appl. No.: 10/489,176

(22) PCT Filed: Sep. 10, 2002
(86) PCT No.: PCT/JP02/09224

(30) Foreign Application Priority Data
Sep. 11, 2001 (JP) 2001-275107
Sep. 11, 2001 (JP) 2001-274800
Sep. 21, 2001 (JP) 2001-288209
Nov. 13, 2001 (JP) 2001-347305

(51) Int. Cl. B62D 25/00

(52) U.S. Cl. 296/1.11

(57) ABSTRACT

A composition which includes a poly(trimethylene terephthalate) resin, and a crystal nucleating agent and/or an inorganic filler, and has a particular crystallization behavior, can be utilized so as to derive an exterior automotive component which is excellent in appearance properties, weatherability and rigidity, and can be manufactured from an originally colored molded article without the application of a coating to the molded article.

### TECHNICAL FIELD

The present invention relates to a resinous exterior component installed to a motor vehicle, as represented by a door-mirror part, an outer handle, a window-wiper part, a roof rail and the like, and more particularly relates to a resinous exterior automotive component which is excellent in strength and rigidity, with superior surface appearance, with no molding sink and no flow mark, and can be manufactured from an originally colored molded article without the application of coating or plating.

### BACKGROUND ART

Conventionally, for an exterior automotive component, various materials have been proposed and come into practical use. Various parts constituting an automotive door-mirror, for example, a mirror stay, a door-mirror bracket and a door-mirror cover, include a metal part comprising a die-cast aluminum, and a resinous part as described in JP-A-9-58354. Among them, a thermoplastic resinous product is especially useful from the viewpoint of automotive weight-reduction. Furthermore, for an automotive outer-door handle, various materials such as polyacetal resin; polycarbonate resin; an alloy of polycarbonate resin and polyester resin as represented by polybutylene terephthalate; and polyamide resin have been proposed. Besides, for a wiper arm, a wiper-blade frame and the like of which an automotive window-wiper is comprised, various materials such as a metal and a thermoplastic resin have been proposed.

On the other hand, for a roof rail, various materials such as a metal material comprising a die-cast aluminum as described in Japanese Utility-Model Gazette No. 6-67194; an alloy of polybutylene terephthalate resin and acrylonitrile-styrene resin as described in JP-A-11-106518; and polyamide resin as described in JP-A-10-337744 have been proposed.

A metallic exterior automotive component is troublesome, because coating and/or plating have to be applied to the surface from the viewpoint that the exterior component is excellent in strength, rigidity and the like, but a bare surface thereof easily rusts, and from the viewpoint of ornamental design. Furthermore, there has been a problem with the metallic exterior automotive component being heavy due to its high specific-gravity. Recently, the weight saving of body weight has been claimed from the viewpoint of improving automotive mileage. Thus the shifting of an exterior automotive component material from a metal to a thermoplastic resin has been also unexceptionally advanced.

Among resinous materials, polybutylene terephthalate resin (which may be hereinafter abbreviated to “PBT”) is proposed as a material for various exterior automotive components, as exemplified in JP-A-9-291204. However, since PBT is highly crystalline, its transcription properties to a die are inferior due to crystallization when it is molded. Incidentally, as described in the above gazette (JP-A-9-291204), when PBT is denatured with a comonomer or the like for use, the surface appearance thereof is surely improved. However, its weatherability as demanded for exterior automotive components is insufficient. Thus PBT is an unsuitable resin for use as a material for an external part such as an exterior automotive component.

Since polyacetal resin (which may be hereinafter abbreviated to “POM”) is also highly crystalline, its transcription properties to a die are inferior due to crystallization when it is molded. Thus in order to derive a surface appearance with good quality, complicated molding conditions have to be carried out. Furthermore, when POM is mixed with glass fibers or the like, since the mixed material is remarkably deteriorated in appearance, the material has its limit for use as a material for an exterior automotive component which needs rigidity, such as a door-mirror stay or a window wiper. In this case, if coating or plating is applied to the surface of a molded article, it can be used as a product. However, such processes are troublesome and complicated.

Besides, as an exterior automotive component from polyamide resin (which may be hereinafter abbreviated to “PA”), JP-A-2000-345032 exemplifies a door-mirror part of a composition comprising polyamide-6, semi-aromatic polyamide and an inorganic filler. In this case, compositions except a black-colored composition with carbon black or the like are generally poor in weatherability. Thus in light of ornamental design, for example, in order to derive a color tone such as a white or silver-metallic one, a coating has to be applied to the molded article. Furthermore, there is a problem with PA being high in water-absorbing properties and being deteriorated in mechanical physical properties such as rigidity when it absorbs water. Thus from the viewpoint of preventing water absorption, some countermeasure such as an application of a coating thereto is required.

JP-A-11-106518 exemplifies an exterior automotive component using an alloy of polycarbonate resin (which may be hereinafter abbreviated to “PC”), PBT and acrylonitrile-styrene resin (which may be hereinafter abbreviated to “AS”) together with carbon black. However, in this case, the exterior automotive component is limited to a black-colored molded article. Thus for a similar reason to the one in PA mentioned above in light of ornamental design, the application of a coating or plating to the molded article is required so as to provide a color tone such as silver-metallic. Furthermore, when the above alloy is provided for injection molding, there is a concern that inferiority in appearance due to molding sink may be caused. Thus injection-molding conditions have to be carefully selected.

JP-A-2001-59034 exemplifies a door-mirror part of acrylonitrile-butadiene-styrene copolymer (which may be hereinafter abbreviated to “ABS resin”). In this case, ABS resin is generally poor in weatherability. Thus in order to use it for an automotive door-mirror part, a coating has to be applied to a molded article therefrom.

The present invention has been accomplished in consideration of these circumstances, whose object is to provide a resinous exterior automotive component comprising an originally colored molded article, which is excellent in weatherability, strength and rigidity as well as surface appearance.

Furthermore, a resinous exterior automotive component is frequently provided with ribs from the viewpoint of structural design or molding-flow properties. Based on this, the phenomenon of “molding sink” is caused, whereby the appearance of the derived exterior automotive component may be spoiled. Thus it is also an object of the present invention to prevent the occurrence of this phenomenon of “molding sink”.

### DISCLOSURE OF THE INVENTION

The present inventor has found that a composition which includes a poly(trimethylene terephthalate) resin of a thermoplastic polyester resin, and a crystal nucleating agent and/or an inorganic filler, and has a particular crystallization behavior, can be utilized as an exterior automotive component material so as to derive an exterior automotive component which is excellent in strength, rigidity and surface appearance as well as weatherability under various color tones such as white and silver-metallic tones as well as a black tone. A molded article of an exterior automotive component comprising such a composition does not require the application of a coating or plating thereto, and can be manufactured from an originally colored molded article.

The wording “an exterior automotive component” as referred to with respect to the present invention means each of various parts produced from a resin as described in James Maxwell: “Other exterior components” of “Plastics in the automotive industry” published by Woodhead Publishing Ltd. and Society of Automotive Engineers, Inc., 1994, p.111-118; and a resinous roof rail component which is mounted on the roof of a motor vehicle for the purpose of the transportation of a load, the decoration of the motor vehicle, or the like. Besides, an exterior automotive component as referred to with respect to the present invention includes various parts constituting the exterior automotive component, for example, automotive door-mirror parts such as a door-mirror stay, a door-mirror bracket and a door-mirror cover.

That is, the present invention relates to the following inventions:

[1] An exterior automotive component, comprising a composition including poly(trimethylene terephthalate) resin (A), and a crystal nucleating agent (B) and/or an inorganic filler (C), wherein said composition has crystallization behaviors as described by the following (1) and (2):

(1) the crystallization starting temperature “T_{c}” when by means of a differential thermal scanning calorimeter, 10 to 20 mg of said composition is heated from room temperature to a temperature of 280° C. at a temperature-rising rate of 100° C./minute, and the temperature is maintained for a period of two minutes, and thereafter the composition is quenched to a temperature of 23° C. at a preset temperature-lowering rate of 500° C./minute, is 170° C. or less; and

(2) a crystallization peak-period when by means of a differential thermal scanning calorimeter, 10 to 20 mg of said composition is heated from room temperature to a temperature of 280° C. at a temperature-rising rate of 100° C./minute, and the temperature is maintained for a period of two minutes, and thereafter the composition is quenched to a temperature of T° C. at a preset temperature-lowering rate of 500° C./minute, and subsequently the temperature of T° C. is maintained, is +20 seconds or less in the whole temperature range of T, wherein the temperature “T° C.” is in the range of 60 to 120° C.

[2] An exterior automotive component according to the item [1], wherein said composition further includes a coloring agent (D) in an amount of 0.01 to 10.0 parts by weight per 100 parts by weight of poly(trimethylene terephthalate) resin(A).

[3] An exterior automotive component according to the item [1] or [2], wherein said composition further includes a weathering agent (E) in an amount of 0.01 to 5.0 parts by weight per 100 parts by weight of poly(trimethylene terephthalate) resin (A).

[4] An exterior automotive component according to any one of the items [1] to [3], wherein the amount of said inorganic filler (C) is 70% by weight or less based on the total of poly(trimethylene terephthalate) resin (A) and said inorganic filler (C).

[5] An exterior automotive component according to any one of the items [1] to [4], wherein said inorganic filler (C) is a glass material of one or more selected from the group consisting of glass fibers, glass beads and glass flakes.

[6] An exterior automotive component according to any one of the items [1] to [4], wherein said inorganic filler (C) is a material of one or more selected from the group consisting of talc, mica, wollastonite, kaolin, calcium carbonate, carbon fiber, and potassium-titanate whisker.

[7] An exterior automotive component according to any one of the items [1] to [6], wherein said exterior automotive component has a rib structure.

[8] An exterior automotive component according to any one of the items [1] to [7], wherein said exterior automotive component is an automotive door-mirror part.

[9] An exterior automotive component according to the item [8], wherein said automotive door-mirror part is a door-mirror stay.

[10] An exterior automotive component according to the item [8], wherein said automotive door-mirror part is a door-mirror bracket.

[11] An exterior automotive component according to the item [8], wherein said automotive door-mirror part is a door-mirror cover.

[12] An exterior automotive component according to any one of the items [1] to [7], wherein said exterior automotive component is an automotive outer-handle.

[13] An exterior automotive component according to any one of the items [1] to [7], wherein said exterior automotive component is an automotive window-wiper component.

[14] An exterior automotive component according to the item [13], wherein said automotive window-wiper component is a wiper arm.

[15] An exterior automotive component according to any one of the items [1] to [7], wherein said exterior automotive component is a roof rail.

[16] An exterior automotive component according to any one of the items [1] to [7], wherein said exterior automotive component is a roof-rail leg.

### BRIEF DESCRIPTION OF DRAWINGS

FIG. 1 is a perspective view of an automotive door-mirror stay;

FIG. 2 is a perspective view of an automotive wiper-arm;

FIG. 3 is a perspective view of an automotive outdoor-handle;

FIG. 4 is a perspective view of an automotive roof-rail leg; and

FIG. 5 is a temperature profile from a differential scanning calorimeter on the occasion of determining a crystallization peak-period, and a schematic depiction of derived charts.

Incidentally, in the drawings the reference numerals “1” and “2” indicate an automotive door-mirror stay, and a cut-out segment of a specimen for weatherability evaluations thereof, respectively; the numerals “3” and “4” indicate an automotive wiper-arm, and a segment for weatherability evaluations thereof, respectively; the numerals “5”, “6” and “7” indicate an automotive outdoor-handle gripper, attachment legs for the automotive outdoor-handle gripper, and a segment for the weatherability evaluations thereof, respectively; and “8” and “9” indicate an automotive roof-rail leg, and a segment for the weatherability evaluations thereof, respectively.

### BEST MODE FOR CARRYING OUT THE INVENTION

The present invention will be hereinafter described in detail.

A poly(trimethylene terephthalate) resin (which may be hereinafter abbreviated to “PTT”) as referred to with respect to the present invention is a polyester resin which is prepared by using terephthalic acid of a dicarboxylic acid as a main acidic constituent, and a trimethylene glycol as a main glycol constituent.

As other acidic constituents except terephthalic acid, an aromatic dicarboxylic acid except terephthalic acid, such as phthalic acid, isophthalic acid, 2,6-naphthalenedicarboxylic acid, diphenyldicarboxylic acid, diphenyl ether dicarboxylic acid, diphenoxyethanedicarboxylic acid, diphenylmethanedicarboxylic acid, diphenylketonedicarboxylic acid or diphenylsulfonedicarboxylic acid; an aliphatic dicarboxylic acid such as succinic acid, adipic acid or sebacic acid; an alicyclic dicarboxylic acid such as cyclohexane dicarboxylic acid; an oxydicarboxylic acid such as ε-oxycaproic acid, hydroxybenzoic acid or hydroxyethoxybenzoic acid can be exemplified. Incidentally, terephthalic acid is preferably used in an amount of 80 mole % or more of the acidic constituent.

A trimethylene glycol is selected from the group consisting of 1,3-propanediol, 1,2-propanediol, 1,1-propanediol, 2,2-propanediol, or a mixture thereof. From the viewpoint of stability, 1,3-propanediol is particularly preferred, and preferably used in an amount of 80 mole % or more based on the glycol constituent.

As other glycol constituents, ethylene glycol, tetramethylene glycol, pentamethylene glycol, hexamethylene glycol, octamethylene glycol, neo-pentyl glycol, cyclohexane dimethanol, xylylene glycol, diethylene glycol, polyoxyalkylene glycol and hydroquinone can be exemplified.

Additionally, the above polyester may be copolymerized with a branching constituent, for example, an acid having tri- or tetra-functional ester formation-potency, such as tricarballylic acid, trimesic acid or trimellitic acid; or an alcohol having tri- or tetra-functional ester formation-potency, such as glycerin, trimethylolpropane or pentaerythritol, wherein the branching constituent is in an amount of 1.0 mole % or less based on the total dicarboxylic acid constituents, preferably 0.5 mole % or less, and more preferably 0.3 mole % or less. Furthermore, PTT may be used in combination with two or more of these copolymerization constituents.

As a method of producing PTT used in the present invention, a method based upon processes as described in, for example, JP-A-51-140992, JP-A-5-262862 and JP-A-8-311177 can be enumerated, but is not particularly limited thereto, wherein terephthalic acid or its ester-forming derivative (for example, a lower alkyl ester such as dimethyl ester or monomethyl ester), and trimethylene glycol or its ester-forming derivative are heat-reacted with each other in the presence of a catalyst at an appropriate temperature for a reasonable period of time, followed by the condensation-polymerization reaction of a derived glycol ester of terephthalic acid in the presence of a catalyst to a desired polymerization degree at an appropriate temperature for a reasonable period of time.

Preferably, PTT used in the present invention has a number average molecular weight of 5,000 to 100,000, and an Mw/Mn of 1.5 to 4.5 which indicates a molecular weight distribution. Furthermore, PTT having a molecular weight of 100,000 or more is preferably included therein in an amount of 1 to 20%.

The number average molecular weight and the molecular weight distribution can be determined according to a procedure such as Osmometry, End-group determination method, or GPC (Gel Permeation Chromatography). Specifically, GPC can be carried out by using “HLC-8120” of Tosoh Corp. as a measuring device, “HFIP804-803 (two pieces of 30 cm column)” of Showa Denko K. K. as columns, hexafluoroisopropanol (which is hereinafter referred to “HFIP”) as a carrier, and “PMMA” of Polymer Laboratories Ltd. as a standard sample at a temperature of 40° C. at a flow rate of 0.5 ml/minute.

An exterior automotive component of the present invention has to be shaped from a poly(trimethylene terephthalate) resin composition having a particular crystallization behavior. That is, the use of a poly(trimethylene terephthalate) resin composition having the above crystallization behavior for an exterior automotive component can provide satisfactorily excellent compactibility, appearance properties, weatherability, product strength and the like therefor.

The wording “the crystallization starting temperature T_{c}” as referred to with respect to the present invention means the temperature of a sample of a resinous composition when the top of an endothermic peak accompanied by the crystallization of a crystalline resin is observed, which is manifested when by means of a differential thermal scanning calorimeter, 10 to 20 mg of the sample is heated from room temperature to a temperature of 280° C. at a temperature-rising rate of 100° C./minute, and the same temperature is maintained for a period of two minutes, and thereafter the sample is quenched to a temperature of 23° C. at a preset temperature-lowering rate of 500° C./minute. Incidentally, when a plurality of endothermic peaks are manifested, an endothermic peak which is first observed shall be employed as an object to be observed.

If the crystallization starting temperature “T_{c}” is 170° C. or less, the crystallization rate of a crystalline resin becomes moderate when the crystalline resin is solidified in a mold in injection molding. For example, when glass fibers or the like are compounded therewith, a molded article having an excellent appearance with no glass-relief on the surface can be derived, and thus such a molded article is suitable for an exterior automotive component of the present invention. The crystallization starting temperature “T_{c}” is more preferably 165° C. or less, and still more preferably 160° C. or less.

Furthermore, the wording “a crystallization peak-period” as referred to with respect to the present invention means the difference “t2−t1” between the time “t1” and the time “t2” wherein “t1” is a time when the temperature of a sample of a resinous composition has attained T° C., and “t2” is a time when the top of an endothermic peak which is manifested from the start of temperature-lowering to the duration of the maintenance of a temperature of T° C. has been observed, provided that by means of a differential thermal scanning calorimeter, 10 to 20 mg of the sample is heated from room temperature to a temperature of 280° C. at a temperature-rising rate of 100° C./minute, the temperature is maintained for a period of two minutes, and thereafter the sample is quenched to the temperature of T° C. at a preset temperature-lowering rate of 500° C./minute, and subsequently the temperature of T° C. is maintained for a period of ten minutes. Incidentally, the wording “the temperature T” is in the temperature range of 60 to 120° C. Besides, when a real injection molding is considered, the surface temperature of the mold is not strictly homogeneous and there exists a temperature distribution, and thus the crystallization peak-period has to be +20 seconds or less in a wide range of temperature, that is, in the whole temperature range of the temperature “T”.

Furthermore, an endothermic peak is manifested accompanied with the crystallization of a crystalline resin. When a plurality of endothermic peaks are manifested, an endothermic peak as last observed shall be employed as an object to be observed.

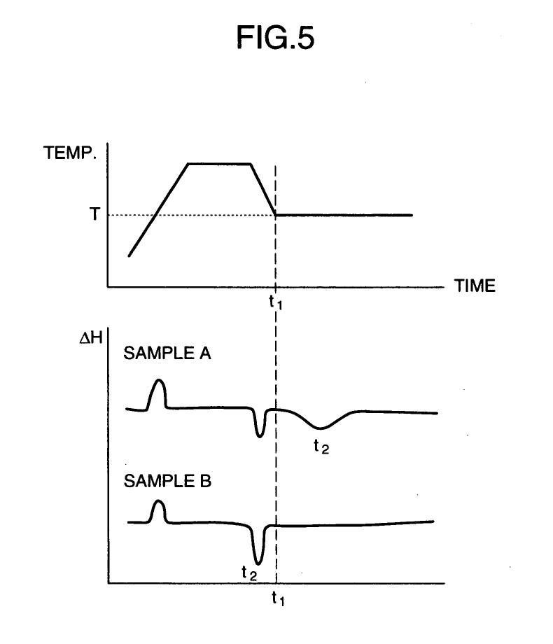

Here, the present invention includes the case that the crystallization peak-period is a negative value. Hereinafter, the wording “a crystallization peak-period” will be explained with FIG. 5. FIG. 5 is a temperature profile from a differential scanning calorimeter on the occasion of determining a crystallization peak-period, and a schematic depiction of derived charts. In the case of the sample “A”, an endothermic peak which is lastly observed is manifested when the sample temperature is maintained to T° C., and thus the crystallization peak-period is a positive value. On the other hand, in the case of the sample “B”, the top of an endothermic peak has been manifested when the sample temperature is T° C., which results in the relation “t2<t1”, and thus the crystallization peak-period is a negative value.

The temperature range in the present invention, that is, the temperature “T”=60 to 120° C. is the same as the mold temperature used generally in common injection-molding. When the crystallization peak-period is +20 seconds or less, the crystallization rate becomes moderate, and thus the cooling retention-time in the mold can be shortened, which is economically advantageous. The crystallization peak-period is preferably +10 seconds or less, and more preferably ±0 second or less.

Since a crystalline thermoplastic polyester resin is excellent in mechanical properties, physical and chemical properties, and the like, its use as a material for an exterior automotive component has been variously proposed. However, PBT, which is a typical thermoplastic polyester resin, has a high crystallization-starting temperature T_{c} as well as a remarkably high crystallization-rate. Thus residual strain when it is molded and/or a poor appearance are easily caused. Furthermore, PBT has a remarkably high crystallization-rate, which can not be easily controlled with an additive agent or the like.

On the other hand, since a poly(ethylene terephthalate) resin (which may be hereinafter abbreviated to “PET”) has a remarkably low crystallization-rate, it has to be blended with a particular crystal nucleating agent as seen in, for example, JP-A-7-247411. Even in such a case, when a suitable exterior automotive component is injection-molded, the complicated molding-conditions have to be imposed: for example, if the mold temperature is not maintained at a remarkably high temperature (140 to 150° C.), the mold-release characteristics are poor. Thus PET is not suitable as a material for an exterior automotive component.

Incidentally, a poly(trimethylene terephthalate) resin of the present invention may be a mixture of poly(trimethylene terephthalate) and another polyester resin such as poly(ethylene terephthalate) or poly(butylene terephthalate).

A crystal nucleating agent (B) as used in the present invention is preferably a known compound which is commonly used as a crystal nucleating agent for a crystalline thermoplastic polyester resin. For example, talc, mica, boron nitride, kaolin, silica, clay, a metallic oxide, an inorganic carboxylate, an inorganic sulfonate, an organic carboxylate, an organic sulfonate, an organic carboxylic acid ester, a carbonate, an ionic copolymer comprising an α-olefin and an α,β-unsaturated carboxylate, or the like is preferably used. Among others, a fatty-acid metallic salt represented by the following general formula (1):

CH₃(CH₂)ₙCOO(M) (1)

wherein n≧0, and M=Na, Ca or Li, is more preferably used.

Among fatty-acid metallic salts, a higher fatty-acid Na-salt, a higher fatty-acid Ca-salt, and a higher fatty-acid Li-salt are still more preferred.

These individual crystal nucleating agents may be independently used, or may be used in the form of a mixture thereof.

The loading of a crystal nucleating agent is not specifically limited, provided that the crystallization starting temperature “T_{c}” of a poly(trimethylene terephthalate) resin composition, and the crystallization peak-period thereof are within the range as defined in the present invention. The loadings are properly selected depending upon the sort, combination, performance and the like of the crystal nucleating agent to be used.

An inorganic filler (C) as referred to with respect to the present invention means a known inorganic filler as commonly incorporated into a thermoplastic polyester resin. Among others, some inorganic fillers such as talc, kaolin, mica and glass fiber have the property of acting as a crystal nucleating agent of the ingredient (B), depending upon the sort or the like of a thermoplastic polyester resin to be used.

In the present invention, one or more selected from the group consisting of glass fibers, glass beads and glass flakes is preferably used as an inorganic filler (C), wherein glass fibers are not specifically limited, provided that the glass fibers are commonly used together with a polyester resin. Furthermore, the number average fiber length (which is hereinafter referred to as “L”) of glass fibers in the composition, the number average fiber diameter (which is hereinafter referred to as “D”) thereof, and the ratio of “L” to “D” (which is also hereinafter referred to as “L/D”) are also not specifically limited. However, preferably L is 100 μm or more, and L/D is 20 or more. Glass fibers are preferably blended in an amount of 70% by weight or less based on the total weight of a poly(trimethylene terephthalate) resin and glass materials from the viewpoint of the surface appearance of a molded part to be made. Besides, when glass fibers are used together with other glass materials such as glass beads and/or glass flakes, the total weight of glass materials to be used is preferably 70% by weight or less based on the total weight of a resin and the glass materials.

Furthermore, as the above glass fibers, particularly surface-treated ones are preferably used. The surface treatment is carried out with a known coupling agent and/or film-forming agent. As coupling agents which are preferably used, a silane coupling-agent, and a titanium coupling-agent can be enumerated.

As silane coupling-agents, triethoxysilane, vinyltris(β-methoxy-ethoxy)silane, γ-methacryloxypropyltrimethoxysilane, γ-glycidoxypropyltrimethoxysilane, β-(1,1-epoxycyclohexyl)ethyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyltrimethoxysilane, γ-chloropropyltrimethoxysilane, γ-aminopropyltrimethoxysilane, γ-aminopropyl-tris(2-methoxy-ethoxy)silane, N-methyl-γ-aminopropyltrimethoxysilane, N-vinylbenzyl-γ-aminopropyltriethoxysilane, triaminopropyltrimethoxysilane, 3-ureidopropyltrimethoxysilane, 3-4,5-dihydroimidazolepropyltriethoxysilane, hexamethyldisilazane, N,O-bis(trimethylsilyl)amide, N,N-bis(trimethylsilyl)urea, and the like can be enumerated.

Among others, aminosilanes and epoxysilanes, such as γ-aminopropyltrimethoxysilane, N-β-(aminoethyl)-γ-aminopropyltrimethoxysilane, γ-glycidoxypropyltrimethoxysilane and β-(1,1-epoxycyclohexyl)ethyltrimethoxysilane, are preferably used.

As titanium coupling-agents, isopropyltriisostearoyl titanate, isopropyltridodecylbenzenesulfonyl titanate, isopropyltris(dioctylpyrophosphate)titanate, tetraisopropylbis(dioctylphosphate)titanate, tetraoctylbis(ditridecylphosphite)titanate, tetra(1,1-diallyloxymethyl-1-butyl)bis(ditridecyl)phosphite titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropylisostearoyldiacryl titanate, isopropyltri(dioctylphosphate)titanate, isopropyltricumylphenyl titanate, isopropyltri(N-amideethyl, aminoethyl)titanate, dicumylphenyloxyacetate titanate, diisostearoylethylene titanate, and the like can be enumerated.

As film-forming agents, polymers, for example, an urethane polymer; an acrylic polymer; a copolymer of maleic anhydride and an unsaturated monomer such as ethylene, α-methylstyrene, butadiene, isoprene, chloroprene, 2,3-dichlorobutadiene, 1,3-pentadiene or cyclooctadiene; an epoxy polymer; a polyester polymer; a vinyl acetate polymer; a polyether polymer; can be enumerated. Among others, an epoxy polymer; an urethane polymer; an acrylic polymer; a butadiene maleic-anhydride copolymer; an ethylene maleic-anhydride copolymer; a styrene maleic-anhydride copolymer; and a mixture thereof; are preferably used.

Furthermore, as preferred inorganic fillers, talc, mica, wollastonite, kaolin, calcium carbonate, carbon fiber, potassium-titanate whisker and the like in addition to glass materials can be enumerated.

As other inorganic fillers, a fibrous inorganic filler such as asbestos fibers, silica fibers, silica-alumina fibers, zirconia fibers, boron-nitride fibers, silicon-nitride fibers or boron fibers; and a fibrous material of a metal such as stainless steel, aluminum, titanium, copper or brass; can be enumerated.

Additionally, silica, ground quartz, calcium silicate, aluminum silicate and clay; a silicate such as diatomaceous earth; a metallic oxide such as iron oxide, titanium oxide, zinc oxide or alumina; a metallic carbonate such as magnesium carbonate; a metallic sulfate such as calcium sulfate or barium sulfate; as well as silicon carbide, silicon nitride, and various metallic powders; in the form of powder or granulate, can be also used as an inorganic filler.

Preferably, the content of an inorganic filler shall be 70% by weight or less based on the total weight of a poly(trimethylene terephthalate) resin and the inorganic filler from the viewpoint of the surface appearance of a molded part to be made. Besides, even when two or more inorganic fillers are used together, the total weight of the inorganic fillers shall be preferably 70% by weight or less based on the total weight of a poly(trimethylene terephthalate) resin and the inorganic fillers.

As a combination of two or more inorganic fillers, a combination of glass fibers and talc, mica, wollastonite, kaolin, calcium carbonate or the like is preferred.

Furthermore, in the present invention, a crystal nucleating agent (B) and an inorganic filler (C) are preferably used together.

In the present invention, according to the performance which is required for an exterior automotive component as intended, a coloring agent (D) is preferably added to a poly(trimethylene terephthalate) resin composition which constitutes the exterior automotive component.

A coloring agent (D) as used in the present invention is a pigment, dye or the like which has been conventionally and publicly known as one for a thermoplastic polyester resin. As preferred pigments, organic pigments such as monoazo, condensed-azo, anthraquinone, isoindolinone, heterocyclic, perinone, quinacridone, perylene, thioindigo and dioxazine pigments; and inorganic pigments such as carbon black, titanium oxide, titanium yellow, iron oxide, ultramarine blue, cobalt blue, a calcined pigment and a metallic pigment; can be enumerated.

Besides, as organic dyes, anthraquinone, heterocyclic and perrine dyes can be enumerated.

Here, as carbon blacks, channel black, furnace black, lamp black, thermal black, ketjen black, naphthalene black, and the like are preferably used. These individual carbon blacks may be independently used, and may be used in combination with one or more other carbon blacks, and may be preferably used together with one or more other coloring agents.

Additionally, for the purpose of regulating the specific surface area of carbon black or providing other properties, the surface of carbon black may be preferably acid-treated or alkali-treated for use.

In the present invention, the dibutyl phthalate oil-absorption of carbon black is preferably 10 to 200 ml/100 g, and particularly preferably 30 to 150 ml/100 g. The oil-absorption of carbon black is determined by the steps of charging 10 g of carbon black in a Brabender, little by little dropping dibutyl phthalate therein, and measuring the amount of dibutyl phthalate when the torque of the Brabender has been fixed, followed by converting the measured value into the amount (ml) of dibutyl phthalate per 100 g of carbon black.

Furthermore, preferably the carbon black has a pH in the range of 3 to 11, more preferably in the range of 4 to 10, and particularly preferably in the range of 5 to 9.5. This pH is the pH of an aqueous suspension wherein 1 g of carbon black is dispersed in 20 ml of distilled water.

Preferably the carbon black has a particle size in the range of 10 to 70 nm, more preferably in the range of 10 to 60 nm, and still more preferably in the range of 10 to 50 nm. This particle size is determined through an electronic microscope with carbon black dispersed in chloroform ultrasonically.

Preferably carbon black has a specific surface area in the range of 50 to 300 m²/g according to BET-type cold nitrogen adsorption method, more preferably in the range of 50 to 200 m²/g, and still more preferably in the range of 50 to 150 m²/g.

As metallic pigments used as a coloring agent (D), a particle of a metal such as aluminum, colored aluminum, nickel, tin, copper, gold, silver, platinum, iron oxide, stainless steel or titanium; a pearl-pigment made of mica; color graphite; a color glass fiber; a color glass flake; and the like can be enumerated. Among others, aluminum, nickel, tin and a pearl-pigment made of mica are preferred. These individual pigments may be independently used, and may be used in combination with one or more other pigments.

Preferably the above metallic pigments have an average particle size in the range of 1 to 500 μm in a number average particle size, and more preferably in the range of 5 to 300 μm. When the number average particle size is in the range of 1 to 500 μm, the derived exterior automotive component is excellent in surface smoothness, and the metallic color tone is vividly manifested.

The loadings of a coloring agent are preferably in the range of 0.01 to 10.0 parts by weight per 100 parts by weight of a poly(trimethylene terephthalate) resin, and more preferably 0.05 to 5.0 parts by weight per 100 parts by weight of a poly(trimethylene terephthalate) resin. When the loadings are in the range of 0.01 to 10.0 parts by weight per 100 parts by weight of a poly(trimethylene terephthalate) resin, the color tone of the derived exterior automotive component is vividly manifested, while the mechanical properties which the poly(trimethylene terephthalate) resin intrinsically carries are not decreased.

Besides, in the present invention, according to the performance which is required for an exterior automotive component as intended, a weathering agent (E) is preferably added to a poly(trimethylene terephthalate) resin composition which constitutes the exterior automotive component.

Weathering agents (E) as used in the present invention are preferably an ultraviolet absorber, a light stabilizer and the like which have been commonly used as a weathering agent for a crystalline thermoplastic polyester resin. As ultraviolet absorbers, a benzotriazole compound, a benzophenone compound, an oxalic anilide compound, a triazine compound and the like can be enumerated.

As benzotriazole compounds, for example, 2-(2′-hydroxy-5′-methylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′,5′-diphenyl)-5-benzotriazole, 2-(2′-hydroxy-3′-t-butyl-5′-methylphenyl)-5-chlorobenzotriazole, 2-(2′-hydroxy-5′-t-butyl-5′-methylphenyl)benzotriazole, 2-(2′-hydroxy-3′-s-butyl-5′-butylphenyl)benzotriazole, 2-(2′-hydroxy-5-t-octylphenyl)benzotriazole, 2-(2H-benzotriazol-2-yl)-4,6-bis(1-methyl-1-phenylethyl)-phenol, 2-(3′,5′-bis(1-methyl-1-phenylethyl)-2′-hydroxyphenyl)benzotriazole and the like can be enumerated.

As benzophenone compounds, for example, 2,4-dihydroxybenzophenone, 2-hydroxy-4-methoxybenzophenone, 2-hydroxy-4-t-butoxybenzophenone, 2-hydroxy-4-octoxybenzophenone, 2-hydroxy-4-dodecyloxybenzophenone, 2-hydroxy-4-stearoxybenzophenone, 2-hydroxy-4-phenoxybenzophenone, 2-hydroxy-4-(β-hydroxyethoxy)benzophenone, 2-hydroxy-4-(2′-hydroxy-3′-acryloxypropoxy)benzophenone, 2-hydroxy-4-(2′-hydroxy-3′-methacryloxypropoxyl)benzophenone, 2,2′-dihydroxybenzophenone, 2,2′-dihydroxy-4-methoxybenzophenone, 2,2′-dihydroxy-4-butoxybenzophenone, 2,2′-dihydroxy-4-octoxybenzophenone, 2,2′-dihydroxy-4-lauroxybenzophenone, 2,2′,4,4′-tetrahydroxybenzophenone, 2,2′,4′-trihydro-4-methoxybenzophenone, 2-hydroxy-4-methoxy-4′-chlorobenzophenone, 2,2′-dihydroxy-4,4′-dimethyloxybenzophenone, 2-hydroxy-4-methoxy-2′-methyl-4′-hydroxybenzophenone, 2-hydroxy-4-methoxy-4′-t-butylbenzophenone, 2-hydroxy-4-methoxy-4′-methylbenzophenone, 2-hydroxy-4,4′-dimethoxybenzophenone, 2-hydroxy-4,4′,2′-trimethoxybenzophenone, and 2-hydroxy-4-N-octoxybenzophenone can be enumerated.

As oxalic anilide compounds, for example, 2-ethoxy-2′-ethyloxalic acid bisanilide, 2-ethoxy-5-t-butyl-2′-ethyloxalic acid bisanilide, and 2-ethoxy-3′-dodecyloxalic acid bisanilide can be enumerated.

As triazine compounds, for example, 2,4,6-tris(2-hydroxy-4-octyloxy-phenyl)-1,3,5-triazine, 2-(2-hydroxy-4-hexyloxy-phenyl)-1,3,5-triazine, 2-(2-hydroxy-4-octyloxy-phenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxy-phenyl)-6-(2,4-dimethylphenyl)-1,3,5-triazine, 2-(2-hydroxy-4-octyloxy-phenyl)-4,6-bis(4-methylphenyl)-1,3,5-triazine, 2-(2-hydroxy-4-dodecyloxy-phenyl)-4,6-bis(2,4-dimethylphenyl)-1,3,5-triazine, 2,4,6-tris(2′-hydroxy-4′-isopropyloxyphenyl)-1,3,5-triazine, 2,4,6-tris(2′-hydroxy-4′-n-hexyloxyphenyl)-1,3,5-triazine, 2,4,6-tris(2′-hydroxy-4′-ethoxycarbonylmethoxyphenyl)-1,3,5-triazine, and the like can be enumerated. Among others, 2-(2-hydroxy-4-hexyloxy-phenyl)-1,3,5-triazine is preferably used.

As a light stabilizer, a hindered-amine compound can be enumerated. As hindered-amine compounds, for example, 4-acetoxy-2,2,6,6-tetramethylpiperidine, 4-stearoyloxy-2,2,6,6-tetramethylpiperidine, 4-acryloyloxy-2,2,6,6-tetramethylpiperidine, 4-(phenylacetoxy)-2,2,6,6-tetramethylpiperidine, 4-benzoyloxy-2,2,6,6-tetramethylpiperidine, 4-methoxy-2,2,6,6-tetramethylpiperidine, 4-stearyloxy-2,2,6,6-tetramethylpiperidine, 4-cyclohexyloxy-2,2,6,6-tetramethylpiperidine, 4-benzyloxy-2,2,6,6-tetramethylpiperidine, 4-phenoxy-2,2,6,6-tetramethylpiperidine, 4-(ethylcarbamoyloxy-2,2,6,6-tetramethylpiperidine, 4-(cyclohexylcarbamoyloxy)-2,2,6,6-tetramethylpiperidine, 4-(phenylcarbamoyloxy)-2,2,6,6-tetramethylpiperidine, bis(2,2,6,6-tetramethyl-4-piperidyl)-carbonate, bis(2,2,6,6-tetramethyl-4-piperidyl)-oxalate, bis(2,2,6,6-tetramethyl-4-piperidyl)-malonate, bis(2,2,6,6-tetramethyl-4-piperidyl)-adipate, bis(2,2,6,6-tetramethyl-4-piperidyl)-sebacate, bis(2,2,6,6-tetramethyl-4-piperidyl)-terephthalate, bis(1,2,2,6,6-pentamethyl-4-piperidyl)-carbonate, bis(1,2,2,6,6-pentamethyl-4-piperidyl)-oxalate, bis(1,2,2,6,6-pentamethyl-4-piperidyl)-malonate, bis(1,2,2,6,6-pentamethyl-4-piperidyl)-adipate, bis(1,2,2,6,6-pentamethyl-4-piperidyl)-sebacate, bis(1,2,2,6,6-pentamethyl-4-piperidyl)-terephthalate, 1,2-bis(2,2,6,6-tetramethyl-4-piperidyloxy)-ethane, α,α′-bis(2,2,6,6-tetramethyl-4-piperidyloxy)-p-xylene, bis(2,2,6,6-tetramethyl-4-piperidyl)-tolylene-2,4-dicarbamate, bis(2,2,6,6-tetramethyl-4-piperidyl)-hexamethylene-1,6-dicarbamate, tris(2,2,6,6-tetramethyl-4-piperidyl)-benzene-1,3,5-tricarboxylate, tris(2,2,6,6-tetramethyl-4-piperidyl)-benzene-1,3,4-tricarboxylate, 1-{2-[3-(3,5-di-t-butyl-4-hydroxyphenyl)propionyloxy]ethyl}-4-[3-(3,5-di-t-butyl-4-hydroxyphenyl)propionyloxy]-2,2,6,6-tetramethylpiperidine, dimethyl succinate 1-(2-hydroxyethyl)-4-hydroxy-2,2,6,6-tetramethylpiperidine polycondensate, bis(1,2,2,6,6-pentamethyl-4-piperidyl) 2-(3,5-di-t-butyl-4-hydroxybenzyl)-2-n-butylmalonate, 2,2,6,6-tetramethyl-4-piperidyl-1,2,3,4-butane carboxylate, and 1,2,2,6,6-pentamethyl-4-piperidyl-1,2,3,4-butane carboxylate can be enumerated.

These individual weathering agents may be independently used, and may be preferably used in combination with one or more other weathering agents.

The loadings of a weathering agent are preferably 0.01 to 5.0 parts by weight per 100 parts by weight of a poly(trimethylene terephthalate) resin, more preferably 0.03 to 3.0 parts by weight, and most preferably 0.05 to 2.0 parts by weight. If the loadings are less than 0.01 part by weight, the effects to be obtained by the addition of the weathering agent are no longer manifested, while if the loadings are more than 5.0 parts by weight, the excellent mechanical properties which the poly(trimethylene terephthalate) resin composition intrinsically carries are undesirably decreased.

A poly(trimethylene terephthalate) resin composition of the present invention is, if necessary, blended with an additive agent which has been conventionally and publicly known as the one for a thermoplastic polyester resin, such as an antioxidant, a heat stabilizer, a mold-release agent or a lubricant.

Furthermore, as far as the effects of the present invention are not deteriorated, the poly(trimethylene terephthalate) resin composition may be blended with one or more thermoplastic resins, for example, a polycarbonate resin; an olefin resin such as polyethylene or polypropylene; a styrene resin such as polystyrene, rubber reinforced polystyrene, acrylonitrile-styrene copolymer, or ABS resin; polyacetal; polyamide; modified polyphenylene oxide; polyphenylene sulfide; poly(methyl methacrylate).

The wording “an automotive component” as referred to with respect to the present invention means those as described above. As specifically preferred components, door-mirror components as typified by an outside door-mirror stay, an outside door-mirror bracket and an outside door-mirror cover; windscreen-wiper components such as an outside door-handle and a windscreen wiper-arm; grilles as typified by a roof rail, a roof-rail leg, a radiator grille, a cowl panel grille and a rear trim panel; spoilers as typified by a rear spoiler and a front spoiler; sun-roof components such as a wheel trim and a sun-roof frame; and the like; can be enumerated. Among others, door-mirror components such as an outside door-mirror stay, an outside door-mirror bracket and an outside door-mirror cover; automotive windscreen-wiper components such as an outside door-handle and a windscreen wiper-arm; a roof rail; and a roof-rail leg; are specifically preferred.

The wording “a rib” as referred to with respect to the present invention means a reinforcing component in a molded article, which is used in order to provide the molded article with rigidity and strength without thickening the molded article and to protect the broad flat surface thereof from warping deformation. This rib provides the advantages that the flow of a molding material is smoothed in a cavity, the molding cycle time is shortened as compared with that in case of thickening the molded article, and the molding material is used in a smaller amount.

Generally, in a molded article having a rib projected on the reverse side thereof (or the surface without ornamental design), the shrinkage of a crystalline thermoplastic resin as accompanied by cooling may cause a recession referred to as “molding sink” on the front surface (or the surface with ornamental design) of the molded article opposite the rib on the reverse side. In order to prevent this, a method in which the width of a rib is designed to become narrower as compared to the thickness of an article to be molded so that the rib can be cooled while a resin on the main-body side of the article to be molded maintains its fluid state, whereby no molding sink as accompanied by the shrinkage of the rib is caused on the surface with ornamental design on the main-body side of the molded article, has been often employed. However, in this case, since the width of a rib becomes narrow, the reinforcing effect may not be satisfactorily attained. According to a poly(trimethylene terephthalate) resin composition of the present invention, the rib portion (or the thin-wall portion) of a molded article is rapidly solidified because the crystallization peak-period in the low temperature portion (at 60 to 120° C.) is short, while the solidification on the main-body side (or the thick-wall portion) of the molded article is moderately delayed because the main-body side has a low T_{c} and a proper crystallization rate, and thus the width of the rib does not have to be excessively narrowed as mentioned above.

If necessary, a coating such as a clear coating is also preferably applied to the surface of an exterior automotive component of the present invention in order to improve, for example, scratch-proof properties.

Furthermore, if necessary, paint or the like is also preferably applied to the surface of an exterior automotive component of the present invention.

When an exterior automotive component of the present invention is shaped, a conventionally known injection-molding method is preferably employed. Additionally, a blow injection-molding method may be also preferably employed.

### EXAMPLES

The present invention will now be described with Examples. However, the present invention is not limited by these Examples at all.

First of all, a poly(trimethylene terephthalate) resin, a poly(butylene terephthalate) resin, a polyamide resin, a polyacetal resin, an ABS resin, a glass fiber, talc, a nucleating agent and a weathering agent, and measurement-items and measurement-conditions concerning the derived resin-compositions and compacts (or specimens) therefrom will be described.

(1) Polyester Resin

a-1: a poly(trimethylene terephthalate) resin having a limiting viscosity [η] of 1.02, and a number average molecular weight of 9800, and Mw/Mn=2.5, wherein molecules having a molecular weight of 100,000 or more account for 5.8%.

Incidentally, the limiting viscosity [η] is calculated by the following definitional equation:

[η]=lim 1/C×(ηᵣ−1)[C→0]

wherein ηᵣ is the value of the viscosity of a diluted solution at a temperature of 35° C. of a polyester resin in o-chlorophenol having a purity of 98% or more divided by the viscosity of the above solvent at the same temperature, which is defined as “a relative viscosity”; and C is the weight (gr.) of a solute in 100 ml of the above diluted solution.

a-2: a poly(butylene terephthalate) resin having a limiting viscosity of 1.05.

(2) Polyamide Resin

b-1: UBE nylon 1013B (of Ube Industries, Ltd.)

(3) Polyacetal Resin

c-1: M90-36 (of Polyplastics Co., Ltd.)

(4) ABS Resin

d-1: STYLAC-ABS220B (of Asahi Kasei Corp.)

(5) Glass Fiber

GF-1: a chopped strand having a fiber diameter of 10 μm and a length of 3 mm, as surface-treated with a mixture of an aminosilane coupling agent and an epoxy binder

(6) Talc

MF-1: MICRO ACE L-1 (of NIPPON TALC CO., LTD.)

(7) Nucleating Agent

NAV-1: Sodium Montanate (of Licomont NaV101; of Clariant Japan K.K.)

(8) Weathering Agent

UV-1: Tinuvin 1577FF (of Ciba Specialty Chemicals K.K.)

(9) Crystallization Starting Temperature

By means of a differential thermal scanning calorimeter “type-DSC7” of PerkinElmer, Inc., about 12 mg of a sample of a resinous composition was heated from room temperature to a temperature of 280° C. at a temperature-rising rate of 100° C./minute, and the same temperature was maintained for a period of two minutes, and thereafter the sample was quenched to a temperature of 23° C. at a preset temperature-lowering rate of 500° C./minute. A sample temperature when the top of an endothermic peak accompanied by the crystallization of a crystalline resin was observed, which was first manifested when the sample was quenched, was determined. The sample temperature was defined as “a crystallization starting temperature”.

(10) Crystallization Peak-Period

By means of a differential thermal scanning calorimeter “type-DSC7” of PerkinElmer, Inc., about 12 mg of a sample of a resinous composition was heated from room temperature to a temperature of 280° C. at a temperature-rising rate of 100° C./minute, and the same temperature was maintained for a period of two minutes, and thereafter the sample was quenched to a target temperature “T” of 60° C. at a temperature-lowering rate of 500° C./minute, and subsequently the temperature of 60° C. was maintained for a period of ten minutes. The difference “t2−t1 (seconds)” between the time “t1” and “t2” wherein “t1” is a time when the sample temperature has attained 60° C., and “t2” is a time when the top of an endothermic peak which was manifested from the start of temperature-lowering to the duration of maintaining a temperature of 60° C. has been observed, was determined. The difference is defined as “a crystallization peak-period”. Incidentally, when a plurality of endothermic peaks were manifested, the value determined from the time when the top of an endothermic peak which was latest to be manifested was observed is defined as “a crystallization peak-period”. Furthermore, the sample was replaced with other samples, the target temperatures (T) were set to 70, 80, 90, 100, 110 and 120° C., respectively, and measurements were carried out in a similar manner to the one described above, whereby the crystallization peak-period of each of the samples was determined, and thus crystallization peak-periods in the temperature range of T=60 to 120° C. were evaluated.

(11) Modulus in Flexure: by JIS K 7171

Testing Machine: Tensilon UTC-30T Model of K.K. Orientech

Specimens: 110^{mm}×10^{mm}×4^{mmt}

Test Temperature: 23° C.

Test Rate: 2 mm/min

Absolute-Dry Control: Specimens are left in a desiccator with silica gel at 23° C. for a period of 24 hours for absolute-dry control.

Water-Absorption Control: Specimens are left to stand under the condition of 23° C. and 50% RH for a period of 60 days for water-absorption control.

(12) Surface Appearance (1) of Molded Part

A visual judgement was carried out based upon the following criteria:

∘: No molding sinks and no flow marks were caused on all of 100 shots.

×: Molding sinks and/or flow marks were caused on some molded parts.

(13) Surface Appearance (2) of Molded Part

A visual judgement was carried out based upon the following criteria:

∘: No glass-relief is observed.

×: Glass-relief is observed.

(14) Weatherability

By means of a xenon weatherability test-machine (of SUGA TEST INSTRUMENTS Co., Ltd.), a weatherability test was carried out for a period of 1,000 hours under the condition of ISO4892. Specimens after the test were judged based upon the following criteria:

(A) Color Difference; A AE value (JISZ-8730) was determined by means of a color-difference meter (Handy Color-Tester HC-T of SUGA TEST INSTRUMENTS Co., Ltd.), which indicates that the smaller the value, the smaller the color variation.

(B) Degree of Cracks; The light-irradiation surface of a specimen was observed by means of an 100-power microscope. The degree of the observation was evaluated based upon the following criteria.

Criteria:

0: No cracks are observed;

1: Slight cracks are observed;

2: Long and clear cracks;

3: Long cracks are observed in an amount of twenty or more per visual field; and

4: Cracks are observed in the whole area.

### Example 1

A poly(trimethylene terephthalate) resin (a-1) was mixed with a crystal nucleating agent (NAV-1) at a weight ratio shown in Table 1, and furthermore aluminum powder as a pigment was added to the mixture in an amount of 0.5 part by weight per 100 parts by weight of the poly(trimethylene terephthalate) resin, followed by melt kneading the same by means of a two-axis extruder (of Toshiba Machine Co., Ltd.: TEM35, Two-axis One-direction Screw-rotation type, L/D=47.6 (D=37 mmφ)). Then, the revolution speed of the screw was 300 rpm, the temperature of the cylinder was 260° C., and the extrusion rate was 60 kg/hr. A polymer was discharged in the form of a strand from a tip-nozzle, and water-cooled, followed by cutting so as to derive pellets. The pellets were dried in an atmosphere of nitrogen at a temperature of 120° C. for a period of 5 hours. The pellets were used to determine the crystallization starting temperature, and the crystallization peak-period. The evaluation results are shown in Table 1.

The pellets were used for the injection-molding of a specimen for evaluating the modulus in flexure. Then the values were evaluated when the specimen was absolute-dried and when it was water-absorbed. The molding was carried out at a resin temperature of 260° C. and a mold temperature of 95° C. The evaluation results are shown in Table 3.

Furthermore, the pellets were used for making 100 shots of flat plates having a dimension of 120 mm×80 mm×3 mmt by injection molding so as to evaluate the surface appearance (1) of the individual molded parts, and thereafter the flat plates were set before a weatherability test, followed by the evaluation of the degree of the color difference and cracks. The molding was carried out at a resin temperature of 260° C. and a mold temperature of 95° C. The evaluation results are shown in Table 3.

### Example 2

Pellets were derived in a similar operation to the one in Example 1, except that a poly(trimethylene terephthalate) resin (a-1) was mixed with a glass fiber (GF-1) at a weight ratio shown in Table 1, and furthermore aluminum powder as a pigment was added to the mixture in an amount of 0.5 part by weight per 100 parts by weight of the total of the poly(trimethylene terephthalate) resin and the glass fiber.

The pellets were used so-as to evaluate the crystallization starting temperature, the crystallization peak-period, the modulus in flexure at absolute drying and at water absorption, the surface appearance (1) of the individual molded parts, and the weatherability in a similar manner to the one carried out in Example 1. Simultaneously, the surface appearance (2) of the individual molded parts was also evaluated. The evaluation results are shown in Tables 1 and 3.

### Example 3

Pellets were derived in a similar operation to the one in Example 2, except that a composition in Example 2 was mixed with a crystal nucleating agent (NAV-1) according to the composition as shown in Table 1.

The pellets were used so as to evaluate the crystallization starting temperature, the crystallization peak-period, the modulus in flexure at absolute drying and at water absorption, the surface appearance (1) of the individual molded parts, the surface appearance (2) of the individual molded parts and the weatherability in a similar manner to the one in Example 2. The evaluation results are shown in Tables 1 and 3.

### Example 4

Pellets were derived in a similar operation to the one in Example 2, except that a composition in Example 2 was mixed with a weathering agent (UV-1) according to the composition as shown in Table 1.

The pellets were used so as to evaluate the crystallization starting temperature, the crystallization peak-period, the modulus in flexure at absolute drying and at water absorption, the surface appearance (1) of the individual molded parts, the surface appearance (2) of the individual molded parts and the weatherability in a similar manner to the one in Example 2. The evaluation results are shown in Tables 1 and 3.

### Example 5

Pellets were derived in a similar operation to the one in Example 2, except that a glass fiber (GF-1) in Example 2 was replaced with talc (MF-1), which was mixed at a weight ratio as shown in Table 1.

The pellets were used so as to evaluate the crystallization starting temperature, the crystallization peak-period, the modulus in flexure at absolute drying and at water absorption, the surface appearance (1) of the individual molded parts, and the weatherability in a similar manner to the one in Example 1. The evaluation results are shown in Tables 1 and 3.

### Comparative Example 1

A pelletized poly(trimethylene terephthalate) resin (a-1) was dried in an atmosphere of nitrogen at a temperature of 120° C. for a period of 5 hours, followed by the determination of the crystallization starting temperature and the crystallization peak-period. The evaluation results are shown in Table 2.

The pellets were used for making 100 shots of flat plates having a dimension of 120 mm×80 mm×3 mmt by injection molding so as to evaluate the surface appearance (1) of the individual compacts. The evaluation results are shown in Table 3.

### Comparative Example 2

A poly(butylene terephthalate) resin (a-2) was mixed with aluminum powder as a pigment in an amount of 0.5 part by weight per 100 parts by weight of the poly(butylene terephthalate) resin, followed by deriving pellets in a similar operation to the one in Example 1. The pellets were used so as to evaluate the crystallization starting temperature, the crystallization peak-period, the modulus in flexure at absolute drying and at water absorption, the surface appearance (1) of the individual molded parts, and the weatherability in a similar manner to the one in Example 1. The evaluation results are shown in Tables 2 and 3.

### Comparative Example 3

Weight ratios as shown in Table 2 were employed so as to derive pellets in a similar operation to the one in Example 2, except that a poly(trimethylene terephthalate) resin (a-1) as used in Example 2 was replaced with a poly(butylene terephthalate) resin (a-2). The pellets were used so as to evaluate the crystallization starting temperature, the crystallization peak-period, the modulus in flexure at absolute drying and at water absorption, the surface appearance (1) of the individual molded parts, the surface appearance (2) of the individual molded parts, and the weatherability in a similar manner to the one in Example 2. The evaluation results are shown in Tables 2 and 3.

### Comparative Example 4

Weight ratios as shown in Table 2 were employed so as to derive pellets in a similar operation to the one in Example 2, except that a poly(trimethylene terephthalate) resin (a-1) as used in Example 2 was replaced with a polyamide resin (b-1). The pellets were used so as to evaluate the modulus in flexure at absolute drying and at water absorption, the surface appearance (1) of the individual molded parts, the surface appearance (2) of the individual molded parts, and the weatherability in a similar manner to the one in Example 2. The evaluation results are shown in Tables 2 and 3.

### Comparative Example 5

A polyacetal resin (c-1) was mixed with a glass fiber (GF-1) at a weight ratio shown in Table 2, and furthermore aluminum powder as a pigment was added to the mixture in an amount of 0.5 part by weight per 100 parts by weight of the total of the polyacetal resin and the glass fiber, followed by melt kneading the same by means of a two-axis extruder (of Toshiba Machine Co., Ltd.: TEM35, Two-axis One-direction Screw-rotation type, L/D=47.6 (D=37 mmφ)). Then, the revolution speed of the screw was 300 rpm, the temperature of the cylinder was 200° C., and the extrusion rate was 60 kg/hr. A polymer was discharged in the form of a strand from a tip-nozzle, and water-cooled, followed by cutting so as to derive pellets. The pellets were dried in an atmosphere of nitrogen at a temperature of 80° C. for a period of 5 hours. The pellets were used so as to evaluate the modulus in flexure at absolute drying and at water absorption, the surface appearance (1) of the individual molded parts, the surface appearance (2) of the individual molded parts, and the weatherability in a similar manner to the one in Example 2. Then, the injection molding was carried out at a resin temperature of 200° C. and a mold temperature of 95° C. The evaluation results are shown in Tables 2 and 3.

### Example 6

A poly(trimethylene terephthalate) resin (a-1) was mixed with a crystal nucleating agent (NAV-1) at a weight ratio shown in Table 4, and furthermore a carbon black having an average particle size of 16 μm as a pigment was added to the mixture in an amount of 1.0 part by weight per 100 parts by weight of the poly(trimethylene terephthalate) resin, followed by melt kneading the same so as to derive pellets under similar conditions to the ones in Example 1. The pellets were dried in an atmosphere of nitrogen at a temperature of 120° C. for a period of 5 hours, followed by the determination of the crystallization starting temperature and the crystallization peak-period. The evaluation results are shown in Table 4.

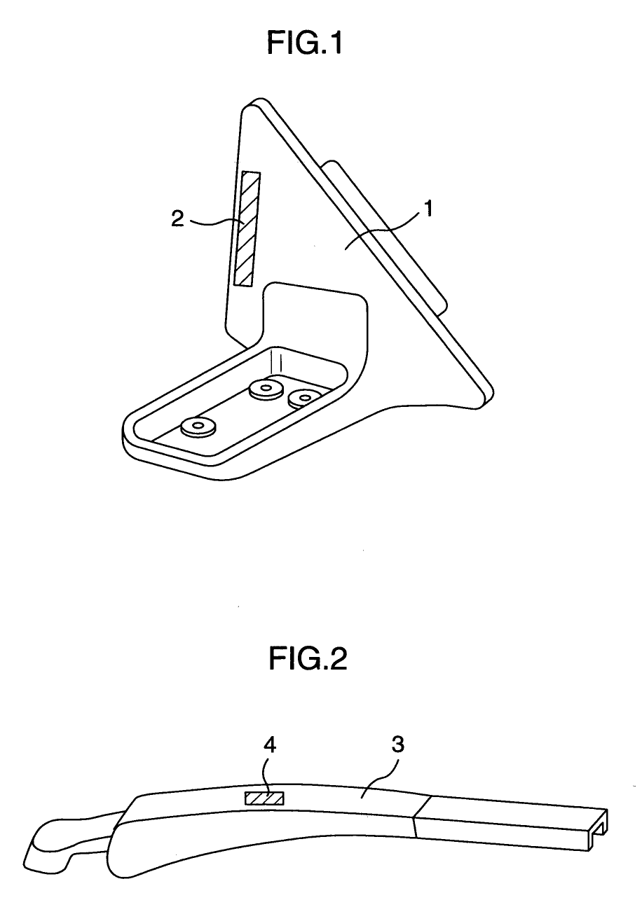

Furthermore, the pellets were used so as to shape an automotive door-mirror stay having a rib on the reverse side as shown in FIG. 1. The shaping was carried out at a resin temperature of 260° C. and a dye temperature of 90° C. by means of a 350-ton injection molding machine.

The surface appearance (1) of the derived molded part was evaluated. The evaluation results are shown in Table 4.

Besides, a rectangular parallelopiped having a dimension of 50 mm×12 mm×3 mm was cut out in the neighborhood of the center section of the derived molded part (shown by “2”) so as to be set before a weatherability test. The evaluation results are shown in Table 4.

### Example 7

A poly(trimethylene terephthalate) resin (a-1) was mixed with a glass fiber (GF-1) and a crystal nucleating agent (NAV-1) at a weight ratio shown in Table 4, and furthermore a carbon black having an average particle size of 16 μm as a pigment was added thereto in an amount of 1.0 part by weight per 100 parts by weight of the total of the poly(trimethylene terephthalate) resin and the glass fiber, followed by melt kneading so as to derive pellets under similar conditions to the ones in Example 1. The pellets were dried in an atmosphere of nitrogen at a temperature of 120° C. for a period of 5 hours, followed by the determination of the crystallization starting temperature and the crystallization peak-period in a similar manner to the one in Example 6. Furthermore, the pellets were used so as to shape an automotive door-mirror stay having a rib on the reverse side as shown in FIG. 1, followed by evaluating the surface appearance (1) of the derived compact and the surface appearance (2) of the compact, and carrying out a weatherability test. The evaluation results are shown in Table 4.

### Comparative Example 6

A poly(butylene terephthalate) resin (a-2) was mixed with a carbon black having an average particle size of 16 μm as a pigment in an amount of 1.0 part by weight per 100 parts by weight of the poly(butylene terephthalate) resin, followed by deriving pellets in a similar operation to the one in Example 6. The pellets were dried in an atmosphere of nitrogen at a temperature of 120° C. for a period of 5 hours, followed by the determination of the crystallization starting temperature and the crystallization peak-period. Furthermore, the pellets were used so as to shape an automotive door-mirror stay, followed by evaluating the surface appearance (1) of the derived compact, and carrying out a weatherability test. The evaluation results are shown in Table 4.

According to the present Comparative Example, a molding sink was manifested on the rib portion of the compact.

### Comparative Example 7

An ABS resin (d-1) was mixed with a carbon black having an average particle size of 16 μm as a pigment in an amount of 1.0 part by weight per 100 parts by weight of the ABS resin, and an automotive door-mirror stay was shaped in a similar operation to the one in Example 6, except for employing a resin temperature of 240° C. and a dye temperature of 70° C., followed by evaluating the surface appearance (1) of the derived compact, and carrying out a weatherability test. The evaluation results are shown in Table 4.

### Comparative Example 8

Weight ratios as shown in Table 4 were employed so as to derive pellets in a similar operation to the one in Example 7, except that a poly(trimethylene terephthalate) resin (a-1) as used in Example 7 was replaced with a poly(butylene terephthalate) resin (a-2). The pellets were dried in an atmosphere of nitrogen at a temperature of 120° C. for a period of 5 hours, followed by the determination of the crystallization starting temperature and the crystallization peak-period. Furthermore, the pellets were used so as to shape an automotive door-mirror stay, followed by evaluating the surface appearance (1) of the derived compact and the surface appearance (2) of the compact, and carrying out a weatherability test. The evaluation results are shown in Table 4.

According to the present Comparative Example, a molding sink was manifested on the rib portion of the compact. Furthermore, an intensive glass-relief was observed on the surface.

### Comparative Example 9

Weight ratios as shown in Table 4 were employed so as to derive pellets in a similar operation to the one in Example 7, except that a poly(trimethylene terephthalate) resin (a-1) as used in Example 7 was replaced with a polyamide resin (b-1). Furthermore, the pellets were used so as to shape an automotive door-mirror stay in a similar operation to the one in Example 7, except for employing a resin temperature of 280° C. and a dye temperature of 80° C., followed by evaluating the surface appearance (1) of the derived compact and the surface appearance (2) of the compact, and carrying out a weatherability test. The evaluation results are shown in Table 4.

According to the present Comparative Example, a glass-relief was observed on the surface.

### Example 8

A poly(trimethylene terephthalate) resin (a-1) was mixed with a glass fiber (GF-1) and talc (MF-1) at a weight ratio shown in Table 5, and furthermore a carbon black having an average particle size of 16 μm as a pigment was added to the mixture in an amount of 1.0 part by weight per 100 parts by weight of the total of the poly(trimethylene terephthalate) resin, the glass fiber and the talc, followed by melt kneading the same so as to derive pellets under similar conditions to the ones in Example 1. The pellets were dried in an atmosphere of nitrogen at a temperature of 120° C. for a period of 5 hours, followed by the determination of the crystallization starting temperature and the crystallization peak-period. The evaluation results are shown in Table 5.

Furthermore, the pellets were used so as to make an automotive wiper-component which is a wiper arm having a rib on the reverse side as shown in FIG. 2. The shaping was carried out at a resin temperature of 260° C. and a dye temperature of 95° C. by means of a 350-ton injection molding machine.

The surface appearance (1) of the derived molded part and the surface appearance (2) of the molded part were evaluated. The results are shown in Table 5.

Furthermore, this molded part was set before a weatherability test so as to evaluate the color difference and the degree of cracks in the center of the molded part (that is, a portion shown by the reference numeral “4” in FIG. 2). The evaluation results are shown in Table 5.

### Comparative Example 10

Weight ratios as shown in Table 5 were employed so as to derive pellets in a similar operation to the one in Example 8, except that a poly(trimethylene terephthalate) resin (a-1) as used in Example 8 was replaced with a poly(butylene terephthalate) resin (a-2). The pellets were dried in an atmosphere of nitrogen at a temperature of 120° C. for a period of 5 hours, followed by the determination of the crystallization starting temperature and the crystallization peak-period. The evaluation results are shown in Table 5. Furthermore, the pellets were used so as to make a wiper arm.

Besides, the surface appearance (1) of the derived molded part and the surface appearance (2) of the molded part, and the weatherability were evaluated in a similar manner to the one in Example 8. The evaluation results are shown in Table 5.

According to the present Comparative Example, a remarkably large warping-camber was observed on the molded part. Furthermore, a molding sink on the rib portion thereof as well as a glass-relief on the surface was observed.

### Example 9

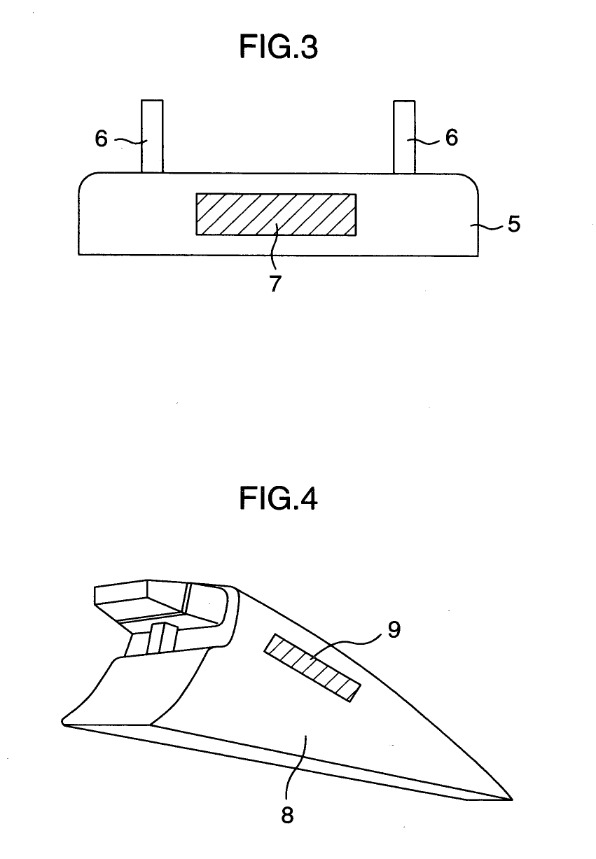

Pellets as used in Example 6 were dried in an atmosphere of nitrogen at a temperature of 120° C. for a period of 5 hours, followed by shaping an automotive outdoor-handle component having a rib on the reverse side in a shape as shown in FIG. 3 from the pellets.

The shaping was carried out at a resin temperature of 260° C. and a dye temperature of 90° C. by means of a 350-ton injection molding machine.

The surface appearance (1) of the derived compact was evaluated. The evaluation result is shown in Table 5.

Furthermore, the derived compact was set before a weatherability test, followed by the determination of the color difference and the degree of cracks in the neighborhood of the center section of the compact (shown by “7”) after the test. The evaluation results are shown in Table 5.

### Example 10

A poly(trimethylene terephthalate) resin (a-1) was mixed with a glass fiber (GF-1) and a crystal nucleating agent (NAV-1) at a weight ratio shown in Table 5, and furthermore a carbon black having an average particle size of 16 μm as a pigment was added to the mixture in an amount of 1.0 part by weight per 100 parts by weight of the total of the poly(trimethylene terephthalate) resin and the glass fiber, followed by melt kneading the same so as to derive pellets under similar conditions to the ones in Example 1. The pellets were dried in an atmosphere of nitrogen at a temperature of 120° C. for a period of 5 hours, followed by the determination of the crystallization starting temperature and the crystallization peak-period. The evaluation results are shown in Table 5.

Furthermore, the pellets were used so as to shape an automotive outdoor-handle component having a rib on the reverse side in a shape as shown in FIG. 3 in a similar manner to the one in Example 9, followed by evaluating the surface appearance (1) of the derived molded part and the surface appearance (2) of the molded part, and carrying out a weatherability test. The evaluation results are shown in Table 5.

### Comparative Example 11

An automotive outdoor-handle component was shaped in a similar operation to the one in Example 9, except that a poly(trimethylene terephthalate) resin (a-1) as used in Example 9 was replaced with a polyacetal resin (c-1), and a resin temperature of 200° C. and a dye temperature of 90° C. were employed.

The surface appearance (1) of this derived molded part and the weatherability were evaluated in a similar manner to the one in Example 9. The evaluation results are shown in Table 5.

According to the present Comparative Example, a molding sink on the rib portion of the molded part was observed.

### Example 11

Pellets as used in Example 7 were dried in an atmosphere of nitrogen at a temperature of 120° C. for a period of 5 hours, followed by shaping an automotive roof-rail leg having a rib on the reverse side in a shape as shown in FIG. 4 from the pellets.

The shaping was carried out at a resin temperature of 260° C. and a dye temperature of 90° C. by means of a 350-ton injection molding machine.

The surface appearance (1) of the derived compact and the surface appearance (2) of the compact were evaluated. The evaluation result is shown in Table 5.

Furthermore, the derived compact was set before a weatherability test, followed by the determination of the color difference and the degree of cracks in the neighborhood of the center section of the compact (shown by “9”) after the test. The evaluation results are shown in Table 5.

### Comparative Example 12

Pellets as used in Example 7 were replaced with pellets as used in Comparative Example 9, followed by shaping an automotive roof-rail leg in a similar operation to the one in Example 11.

In a similar manner to the one in Example 11, the surface appearance (1) of this derived compact and the surface appearance (2) of the compact were evaluated, and a weatherability test was carried out. The evaluation results are shown in Table 5.

According to the present Comparative Example, a glass-relief was observed on the surface of the compact.

TABLE 1

| | | | Example 1 | Example 2 | Example 3 | Example 4 | Example 5 |
|---|---|---|---|---|---|---|---|
| Resin | Polyester Resin Ingredient | | a-1 | a-1 | a-1 | a-1 | a-1 |
| Basic | (Composition; wt. %)*¹ | | 100 | 70 | 70 | 70 | 80 |
| Ingredient | Inorganic | Glass Fiber | — | GF-1 | GF-1 | GF-1 | — |
| | Filler | (Composition; wt. %)*¹ | — | 30 | 30 | 30 | — |
| | | Talc | — | — | — | — | MF-1 |
| | | (Composition; wt. %)*¹ | — | — | — | — | 20 |

| | | | | | | |
|---|---|---|---|---|---|---|
| Additive | Crystal Nucleating Agent | NAV-1 | — | NAV-1 | — | — |
| Agent | (Composition; part by weight)*² | 0.10 | — | 0.07 | — | — |
| Ingredient | Weathering Agent | — | — | — | UV-1 | — |
| | (Composition; part by weight)*² | — | — | — | 1.0 | — |
| | Coloring Agent | Aluminum | Aluminum | Aluminum | Aluminum | Aluminum |
| | | Powder | Powder | Powder | Powder | Powder |
| | (Composition; parts by weight)*² | 0.50 | 0.50 | 0.50 | 0.50 | 0.50 |

| Crystallization Starting Temperature (° C.) | | 137 | 140 | 141 | 140 | 138 |
|---|---|---|---|---|---|---|
| Crystallization Peak-Period (seconds) | 60° C. | −52 | −54 | −56 | −54 | −52 |
| | 70° C. | −45 | −48 | −50 | −48 | −45 |
| | 80° C. | −37 | −40 | −42 | −41 | −36 |
| | 90° C. | −31 | −33 | −36 | −34 | −30 |
| | 100° C. | −24 | −26 | −29 | −26 | −23 |
| | 110° C. | −16 | −18 | −20 | −19 | −16 |
| | 120° C. | −10 | −12 | −14 | −13 | −10 |

*¹Composition by weight (% by weight) in a resin basic ingredient; and
*²Compounded composition (parts by weight) per 100 parts by weight of a resin basic ingredient.

TABLE 2

| | | | Comp. | Comp. | Comp. | Comp. | Comp. |
|---|---|---|---|---|---|---|---|
| | | | Ex. 1 | Ex. 2 | Ex. 3 | Ex. 4 | Ex. 5 |
| Resin | Polyester Resin Ingredient | | a-1 | a-2 | a-2 | — | — |
| Basic | (Composition; wt. %)*¹ | | 100 | 100 | 70 | — | — |
| Ingredient | Polyamide Resin Ingredient | | — | — | — | b-1 | — |
| | (Composition; wt. %)*¹ | | — | — | — | 70 | — |
| | Polyacetal Resin Ingredient | | — | — | — | — | c-1 |
| | (Composition; wt. %)*¹ | | — | — | — | — | 70 |
| | Inorganic | Glass Fiber | — | — | GF-1 | GF-1 | GF-1 |
| | Filler | (Compo.; wt. %)*¹ | — | — | 30 | 30 | 30 |
| | | Talc | — | — | — | — | — |
| | | (Compo.; wt. %)*¹ | — | — | — | — | — |

| | | | | | | |
|---|---|---|---|---|---|---|
| Additive | Crystal Nucleating Agent | — | — | — | — | — |
| Agent | (Compo.; part by weight)*² | — | — | — | — | — |
| Ingredient | Weathering Agent | — | — | — | — | — |
| | (Compo.; part by weight)*² | — | — | — | — | — |
| | Coloring Agent | — | Al Powder | Al Powder | Al Powder | Al Powder |
| | (Compo.; parts by weight)*² | — | 0.50 | 0.50 | 0.50 | 0.50 |

| Crystallization Starting Temperature (° C.) | | 124 | 180 | 179 | — | — |
|---|---|---|---|---|---|---|
| Crystallization Peak-Period | 60° C. | 310 | −62 | −61 | — | — |
| (seconds) | 70° C. | 67 | −56 | −55 | — | — |
| | 80° C. | 25 | −48 | −47 | — | — |
| | 90° C. | 22 | −43 | −43 | — | — |
| | 100° C. | 18 | −38 | −37 | — | — |
| | 110° C. | 16 | −34 | −33 | — | — |
| | 120° C. | 14 | −30 | −30 | — | — |

*¹Composition by weight (% by weight) in a resin basic ingredient; and
*²Blending composition (parts by weight) per 100 parts by weight of a resin basic ingredient.

TABLE 3

| | | | | | | | Comp. | Comp. | Comp. | Comp. | Comp. |
|---|---|---|---|---|---|---|---|---|---|---|---|
| | | Ex. 1 | Ex. 2 | Ex. 3 | Ex. 4 | Ex. 5 | Ex. 1 | Ex. 2 | Ex. 3 | Ex. 4 | Ex. 5 |
| in Abs. | Modulus in | 2.75 | 10.4 | 10.5 | 10.4 | 4.89 | — | 2.54 | 9.7 | 8.8 | 8.2 |
| Drying | Flexure | | | | | | | | | | |
| | (GPa) | | | | | | | | | | |
| in | Modulus in | 2.72 | 10.2 | 10.2 | 10.2 | 4.79 | — | 2.49 | 9.5 | 5.3 | 8.0 |
| Water | Flexure | | | | | | | | | | |
| Absorption | (GPa) | | | | | | | | | | |
| | Ratio to | (98.9) | (98.1) | (97.1) | (98.1) | (98.0) | — | (98.0) | (97.9) | (60.2) | (97.6) |
| | the One in | | | | | | | | | | |
| | Abs. | | | | | | | | | | |
| | Drying (%) | | | | | | | | | | |
| Surface Appearance | | ◯ | ◯ | ◯ | ◯ | ◯ | X | ◯ | ◯ | ◯ | X |
| (1) of Compact | | | | | | | | | | | |
| Surface Appearance | | — | ◯ | ◯ | | — | — | — | X | ◯ | X |
| (2) of Compact | | | | | | | | | | | |
| Weather- | Color | 1.9 | 2.3 | 2.2 | 1.4 | 2.4 | — | 5.0 | 5.3 | 24.1 | * |
| ability | Diff. | | | | | | | | | | |
| | (ΔE) | | | | | | | | | | |
| | Crack | 0 | 0 | 0 | 0 | 0 | — | 0 | 0 | 3 | 3 |

| | | |
|---|---|---|
| Remarks | Occurrence | Measurement |
| | of Molding | of Color |
| | Sink is | Difference |
| | remarkable | is incapable |
| | | with |
| | | Intensive |
| | | Glass Relief. |

TABLE 4

| | | | | | Comp. | Comp. | Comp. | Comp. |
|---|---|---|---|---|---|---|---|---|
| | | | Ex. 6 | Ex. 7 | Ex. 6 | Ex. 7 | Ex. 8 | Ex. 9 |
| Resin Basic | Polyester Resin Ingredient | | a-1 | a-1 | a-2 | — | a-2 | — |
| Ingredient | (Composition; % by weight)*¹ | | 100 | 50 | 100 | — | 50 | — |
| | Polyamide Resin Ingredient | | — | — | — | — | — | b-1 |
| | (Composition; % by weight)*¹ | | — | — | — | — | — | 50 |
| | ABS Resin Ingredient | | — | — | — | d-1 | — | — |
| | (Composition; % by weight)*¹ | | — | — | — | 100 | — | — |
| | Inorganic | Glass Fiber | — | GF-1 | — | — | GF-1 | GF-1 |
| | Filler | (Compo.; wt. %)*¹ | — | 50 | — | — | 50 | 50 |

| | | | | | | | |
|---|---|---|---|---|---|---|---|
| Additive | Crystal Nucleating Agent | NAV-1 | NAV-1 | — | — | — | — |
| Agent | (Compo.; part by weight)*² | 0.10 | 0.05 | — | — | — | — |
| Ingredient | Coloring Agent | CB*³ | CB*³ | CB*³ | CB*³ | CB*³ | CB*³ |
| | (Compo.; parts by weight)*² | 1.0 | 1.0 | 1.0 | 1.0 | 1.0 | 1.0 |

| | | | | | | |
|---|---|---|---|---|---|---|
| Crystallization Starting Temp. (° C.) | 136 | 142 | 181 | — | 180 | — |

| | | | | | | | |
|---|---|---|---|---|---|---|---|
| Crystallization Peak-Period | 60° C. | −50 | −56 | −63 | — | −61 | — |
| (seconds) | 70° C. | −43 | −50 | −57 | — | −55 | — |
| | 80° C. | −35 | −44 | −49 | — | −47 | — |
| | 90° C. | −29 | −37 | −44 | — | −43 | — |
| | 100° C. | −21 | −30 | −37 | — | −37 | — |
| | 110° C. | −14 | −22 | −33 | — | −33 | — |
| | 120° C. | −9 | −15 | −29 | — | −30 | — |

| Surface Appearance (1) of Compact | | ◯ | ◯ | X | ◯ | X | ◯ |
|---|---|---|---|---|---|---|---|
| Surface Appearance (2) of Compact | | — | ◯ | — | — | X | X |
| Weather- | Color Difference (ΔE) | 2.0 | 2.3 | 5.2 | 25.1 | 7.4 | 6.8 |
| ability | Crack | 0 | 0 | 0 | 3 | 0 | 1 |

*¹Composition by weight (wt. %) in a resin basic ingredient;
*²Compounded Composition (wt. parts) per 100 wt. parts of Resin Basic Ingredient; and
*³Carbon Black having Average Particle of 16 μm.

TABLE 5

| | | | | Comp. | | | Comp. | | Comp. |
|---|---|---|---|---|---|---|---|---|---|
| | | | Ex. 8 | Ex. 10 | Ex. 9 | Ex. 10 | Ex. 11 | Ex. 11 | Ex. 12 |
| Resin Basic | Polyester Resin Ingredient | | a-1 | a-2 | a-1 | a-1 | — | a-1 | — |
| Ingredient | (Compo.; wt. %)*¹ | | 60 | 60 | 100 | 85 | — | 50 | — |
| | Polyamide Resin Ingredient | | — | — | — | — | — | — | b-1 |
| | (Compo.; wt. %)*¹ | | — | — | — | — | — | — | 50 |
| | Polyacetal Resin Ingredient | | — | — | — | — | c-1 | — | — |
| | (Compo.; wt. %*¹ | | — | — | — | — | 100 | — | — |
| | Inorg. | Glass Fiber | GF-1 | GF-1 | — | GF-1 | — | GF-1 | GF-1 |
| | Filler | (Compo.; wt. %)*¹ | 25 | 25 | — | 15 | — | 50 | 50 |
| | | Talc | MF-1 | MF-1 | — | — | — | — | — |
| | | (Compo.; wt. %)*¹ | 15 | 15 | — | — | — | — | — |

| | | | | | | | | |
|---|---|---|---|---|---|---|---|---|
| Additive | Crystal Nucleating Agent | — | — | NAV-1 | NAV-1 | — | NAV-1 | — |
| Agent | (Compo.; wt. parts)*² | — | — | 0.10 | 0.08 | — | 0.5 | — |
| Ingredient | Coloring Agent | CB*³ | CB*³ | CB*³ | CB*³ | CB*³ | CB*³ | CB*³ |
| | (Compo.; wt. parts)*² | 1.0 | 1.0 | 1.0 | 1.0 | 1.0 | 1.0 | 1.0 |

| Crystallization Starting Temp. (° C.) | | 138 | 179 | 136 | 137 | — | 142 | — |
|---|---|---|---|---|---|---|---|---|
| Crystallization Peak-Period | 60° C. | −52 | −62 | −50 | −51 | — | −56 | — |
| (Seconds) | 70° C. | −46 | −55 | −43 | −45 | — | −50 | — |
| | 80° C. | −40 | −48 | −35 | −39 | — | −44 | — |
| | 90° C. | −33 | −43 | −29 | −34 | — | −37 | — |
| | 100° C. | −25 | −38 | −21 | −26 | — | −30 | — |
| | 110° C. | −16 | −34 | −14 | −16 | — | −22 | — |
| | 120° C. | −10 | −29 | −9 | −11 | — | −15 | — |

| Surface Appearance (1) of Compact | | X | ◯ | ◯ | ◯ | X | ◯ | ◯ |
|---|---|---|---|---|---|---|---|---|
| Surface Appearance (2) of Compact | | X | ◯ | — | ◯ | — | ◯ | ◯ |
| Weather- | Color Difference (ΔE) | 2.2 | 4.8 | 2.0 | 2.1 | 16.8 | 2.4 | 6.4 |
| ability | Crack | 0 | 0 | 0 | 0 | 4 | 0 | 1 |

*¹Composition by weight (wt. %) in a resin basic ingredient;
*²Compounded Composition (wt. parts) per 100 wt. parts of Resin Basic Ingredient; and
*³Carbon Black having Average Particle of 16 μm.

Industrial Applicability

As mentioned above, an exterior automotive component of the present invention is excellent in weatherability and rigidity, with superior surface appearance, and can be manufactured from an originally colored molded article without the application of a coating. Accordingly, it is suitable to be utilized as an automotive component.

1. An exterior automotive component, comprising a composition including poly(trimethylene terephthalate) resin (A), and a crystal nucleating agent (B) and/or an inorganic filler (C), wherein said composition has crystallization behaviors as described by the following (1) and (2):
(1) the crystallization starting temperature “T_{c}” when by means of a differential thermal scanning calorimeter, 10 to 20 mg of said composition is heated from room temperature to a temperature of 280° C. at a temperature-rising rate of 100° C./minute, and the temperature is maintained for a period of two minutes, and thereafter the composition is quenched to a temperature of 23° C. at a preset temperature-lowering rate of 500° C./minute, is 170° C. or less; and
(2) a crystallization peak-period when by means of a differential thermal scanning calorimeter, 10 to 20 mg of said composition is heated from room temperature to a temperature of 280° C. at a temperature-rising rate of 100° C./minute, and the temperature is maintained for a period of two minutes, and thereafter the composition is quenched to a temperature of T° C. at a preset temperature-lowering rate of 500° C./minute, and subsequently the temperature of T° C. is maintained, is +20 seconds or less in the whole temperature range of T, wherein the temperature “T° C.” is in the range of 60 to 120° C.

2. An exterior automotive component according to claim 1, wherein said composition further includes a coloring agent (D) in an amount of 0.01 to 10.0 parts by weight per 100 parts by weight of poly(trimethylene terephthalate) resin (A).

3. An exterior automotive component according to claim 1 or 2, wherein said composition further includes a weathering agent (E) in an amount of 0.01 to 5.0 parts by weight per 100 parts by weight of poly(trimethylene terephthalate) resin (A).

4. An exterior automotive component according to any one of claims 1 to 3, wherein the amount of said inorganic filler (C) is 70% by weight or less based on the total of poly(trimethylene terephthalate) resin (A) and said inorganic filler (C).

5. An exterior automotive component according to any one of claims 1 to 4, wherein said inorganic filler (C) is a glass material of one or more selected from the group consisting of glass fibers, glass beads and glass flakes.

6. An exterior automotive component according to any one of claims 1 to 4, wherein said inorganic filler (C) is a material of one or more selected from the group consisting of talc, mica, wollastonite, kaolin, calcium carbonate, carbon fiber, and potassium-titanate whisker.

7. An exterior automotive component according to any one of claims 1 to 6, wherein said exterior automotive component has a rib structure.

8. An exterior automotive component according to any one of claims 1 to 7, wherein said exterior automotive component is an automotive door-mirror part.

9. An exterior automotive component according to claim 8, wherein said automotive door-mirror part is a door-mirror stay.

10. An exterior automotive component according to claim 8, wherein said automotive door-mirror part is a door-mirror bracket.

11. An exterior automotive component according to claim 8, wherein said automotive door-mirror part is a door-mirror cover.

12. An exterior automotive component according to any one of claims 1 to 7, wherein said exterior automotive component is an automotive outer-handle.

13. An exterior automotive component according to any one of claims 1 to 7, wherein said exterior automotive component is an automotive window-wiper component.

14. An exterior automotive component according to claim 13, wherein said automotive window-wiper component is a wiper arm.

15. An exterior automotive component according to any one of claims 1 to 7, wherein said exterior automotive component is a roof rail.

16. An exterior automotive component according to any one of claims 1 to 7, wherein said exterior automotive component is a roof-rail leg.
